(19) United States
(12) Patent Application Publication
(10) Pub. No.: US 2025/0180087 A1
(43) Pub. Date: Jun. 5, 2025

(54) DAMPER DEVICE

(71) Applicant: PIOLAX, INC., Kanagawa (JP)

(72) Inventor: Jun SAITO, Kanagawa (JP)

(73) Assignee: PIOLAX, INC., Kanagawa (JP)

(21) Appl. No.: 18/842,409

(22) PCT Filed: Mar. 7, 2023
(86) PCT No.: PCT/JP2023/008514

§ 371 Date: Aug. 29, 2024

(30) Foreign Application Priority Data
Mar. 10, 2022 (JP) 2022-037558

(51) Int. Cl. F16F 9/02; F16F 9/32; F16F 9/36; F16F 9/516

(52) U.S. Cl. CPC F16F 9/0218; F16F 9/0227; F16F 9/0281; F16F 9/3214; F16F 9/368; F16F 9/516; F16F 2222/126; F16F 2228/066; F16F 2230/30; F16F 2230/36

(57) ABSTRACT

A damper device includes: a cylinder; a rod; a piston having an annular groove; a seal ring; and a friction member. A seal portion is formed between the cylinder and the piston. When the piston moves in a damper braking direction, the seal ring is configured to press the friction member to expand the friction member in diameter, and an outer peripheral surface of the friction member is configured to be brought into pressure contact with an inner peripheral surface of the cylinder. The friction member is formed to be smaller than a size of the inner peripheral surface of the cylinder when no pressing force is applied from the seal ring.

### TECHNICAL FIELD

The present invention relates to a damper device used to brake opening, closing, and the like of a glove box of an automobile.

### BACKGROUND ART

A damper device may be used in, for example, a glove box of an automobile to prevent a lid from being rapidly opened and allow the lid to be gently opened.

As such a damper device, Patent Literature 1 below describes a damper that includes a piston having a rod and a housing accommodating the piston. The piston includes a seal member facing an inner wall of the housing, and a slider provided to be slidable with respect to the piston and to come into contact with the inner wall of the housing. When a braking force is generated, the slider is brought into pressure contact with the seal member, and a portion of the seal member that is in contact with the inner wall of the housing is deformed toward the outside of the housing.

The seal member has a skirt-shaped portion extending toward an open end of the housing, and the skirt-shaped portion is in contact with the inner wall of the housing. Further, the slider includes a base disposed on an outer periphery of the rod, and a lip extending obliquely outward from the base toward the open end of the housing. When the piston is moved forward (in a damper braking direction), since the shape of the lip makes it difficult for the slider to move in the forward direction, a shoulder of the slider is brought into pressure contact with an end of the skirt-shaped portion of the seal member (see paragraph 0026 of Patent Literature 1).

### CITATION LIST

### Patent Literature

Patent Literature 1: WO2015/093548

### SUMMARY OF INVENTION

### Technical Problem

In the damper of Patent Literature 1, when the piston moves forward, a tip end portion of the lip extending obliquely outward comes into contact with the inner wall of the housing, making it difficult for the slider to move in the forward direction. That is, since the slider is brought into pressure contact with the seal member only by a frictional force of the tip end portion of the lip facing the inner wall of the housing, it is difficult to sufficiently deform the seal member and therefore difficult to obtain a high braking force.

Therefore, an object of the present invention is to provide a damper device capable of obtaining a high damper braking force by sufficiently deforming a friction member in a radial direction when a piston moves in a damper braking direction.

### Solution to Problem

In order to achieve the above object, the present invention provides a damper device configured to be attached between a pair of members that are configured to move toward or away from each other, and configured to apply a braking force when the pair of members move toward or away from each other. The damper device includes: a cylinder having an opening portion at one end portion; a rod movably inserted into the cylinder through the opening portion; a piston connected to the rod and having an annular groove formed on an outer periphery thereof; a seal ring disposed in the annular groove on a side of a damper braking direction in a manner of being movable in an axial direction and configured to come into pressure contact with an inner peripheral surface of the cylinder, and a friction member disposed in the annular groove on a side of a return direction opposite to the damper braking direction with respect to the seal ring. A seal portion is formed between the cylinder and the piston by the seal ring and the friction member, or by the seal ring. An air chamber is formed in the cylinder via the seal portion. When the piston moves in the damper braking direction, the seal ring is configured to press the friction member to expand the friction member in diameter, and an outer peripheral surface of the friction member is configured to be brought into pressure contact with an inner peripheral surface of the cylinder. The friction member is formed to be smaller than a size of the inner peripheral surface of the cylinder when no pressing force is applied from the seal ring.

### Advantageous Effects of Invention

In the present invention, when the piston moves in the damper braking direction, the friction member is pressed against the seal ring by the pressure change in the air chamber and the frictional force of the seal ring against the inner peripheral surface of the cylinder, and the friction member can be sufficiently deformed, so that the outer peripheral surface of the friction member can be brought into pressure contact with the inner peripheral surface of the cylinder. As a result, in addition to the frictional force of the seal ring against the inner peripheral surface of the cylinder, a frictional force of the friction member can be generated against the inner peripheral surface of the cylinder, so that a high damper braking force can be obtained.

### BRIEF DESCRIPTION OF DRAWINGS

FIG. 1 is an exploded perspective view shoving a damper device according to an embodiment of the present invention.

FIG. 2 is a perspective view of the damper device in a state where a rod is pressed in.

FIG. 3 is an enlarged perspective view of a piston forming the damper device.

FIG. 4 is an enlarged perspective view of a seal ring forming the damper device.

FIG. 5 is a cross-sectional view taken along a line B-B in FIG. 4.

FIG. 6 is an enlarged perspective view of a friction member forming the damper device.

FIG. 7 is an enlarged perspective view of the friction member forming the damper device when viewed from a direction different from that of FIG. 5.

FIG. 8 is a cross-sectional view taken along a line E-E in FIG. 6.

FIG. 9 is a perspective view of the damper device in a state in which the seal ring and the friction member are disposed in an annular groove on an outer periphery of the piston.

FIG. 10 is a cross-sectional view taken along a line A-A in FIG. 2.

FIG. 11 (a) is an enlarged cross-sectional view of a part H in FIG. 10, (b) is an enlarged cross-sectional view of a cross-section different from that of (a), and (c) is an enlarged cross-sectional view of a cross-section different from those of (a) and (b).

FIG. 12 is a cross-sectional view of the damper device when the piston is moved in a damper braking direction.

FIG. 13 (a) is an enlarged cross-sectional view of a part I in FIG. 12, (b) is an enlarged cross-sectional view of a cross-section different from that of (a), and (c) is an enlarged cross-sectional view of a cross-section different from those of (a) and (b).

FIG. 14 is a cross-sectional view of the damper device when the piston is moved in are turn direction opposite to the damper braking direction.

FIG. 15 (a) is an enlarged cross-sectional view of a part J in FIG. 14, (b) is an enlarged cross-sectional view of a cross-section different from that of (a), and (c) is an enlarged cross-sectional view of a cross-section different from those of (a) and (b).

FIG. 16 is an enlarged cross-sectional view of a main portion showing a modification of a diameter expansion structure of the friction member using the seal ring.

FIG. 17 is a cross-sectional view showing a damper according to another embodiment of the present invention,

FIG. 18 is an enlarged cross-sectional view of a part M in FIG. 17.

### DESCRIPTION OF EMBODIMENTS

### Damper Device According to One Embodiment

Hereinafter, a damper device according to one embodiment of the present invention will be described with reference to the drawings.

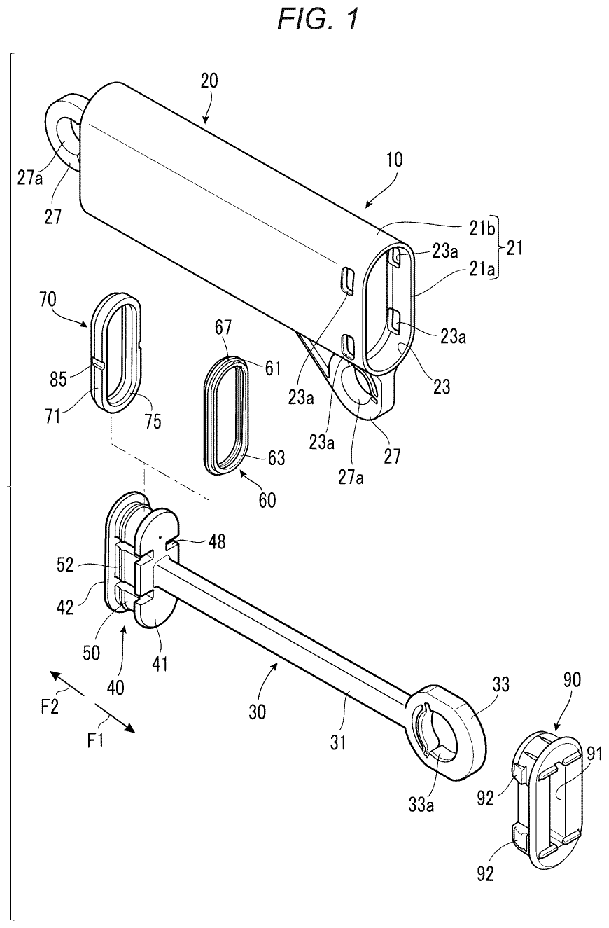

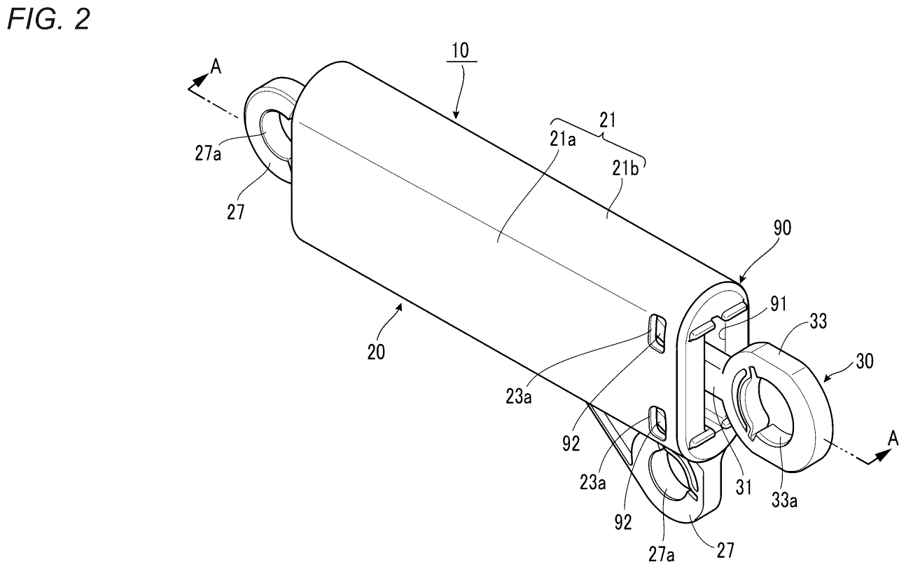

A damper device 10 shown in FIGS. 1 and 2 is attached to a pair of members that approach and separate from each other, and applies a braking force when the pair of members approach or separate from each other. For example, the damper device 10 can be used to brake a glove box, a lid, or the like that is attached to an opening portion of an accommodation portion in an instrument panel of an automobile in a manner of being openable and closable. In the following embodiment, one of the pair of members is described as a fixed body such as the accommodation portion of the instrument panel, and another of the pair of members is described as an openable and closable body such as the glove box or the lid attached to the opening portion of the fixed body in a manner of being openable and closable.

As shown in FIG. 1, the damper device 10 according to the embodiment mainly includes: a cylinder 20 having an opening portion 23 at one end portion; a rod 30 movably inserted into the cylinder 20: a piston 40 connected to the rod 30 and having an annular groove 50 formed on an outer periphery a seal ring 60 disposed on the annular groove 50 at a damper braking direction F1 side in a manner of being movable in an axial direction and in pressure contact with an inner peripheral surface of the cylinder 20: a friction member 70 disposed on the annular groove 50 at a return direction F2 side opposite to a damper braking direction F1 with respect to the seal ring 60; and a detachment prevention cap 90 mounted on the opening portion 23 at the one end portion of the cylinder 20.

Further, when the piston 40 moves in the damper braking direction F1, the seal ring 60 presses the friction member 70 to expand a diameter, and brings an outer peripheral surface of the friction member 70 into pressure contact with the inner peripheral surface of the cylinder 20. The friction member 70 is smaller than the inner peripheral surface of the cylinder 20 when no pressing force acts from the seal ring 60 (this will be described in detail in the following operation description). In the case of this embodiment, the inner peripheral surface of the cylinder 20 refers to the inner peripheral surface of a wall portion 21 forming the cylinder 20, and this also applies to the following description.

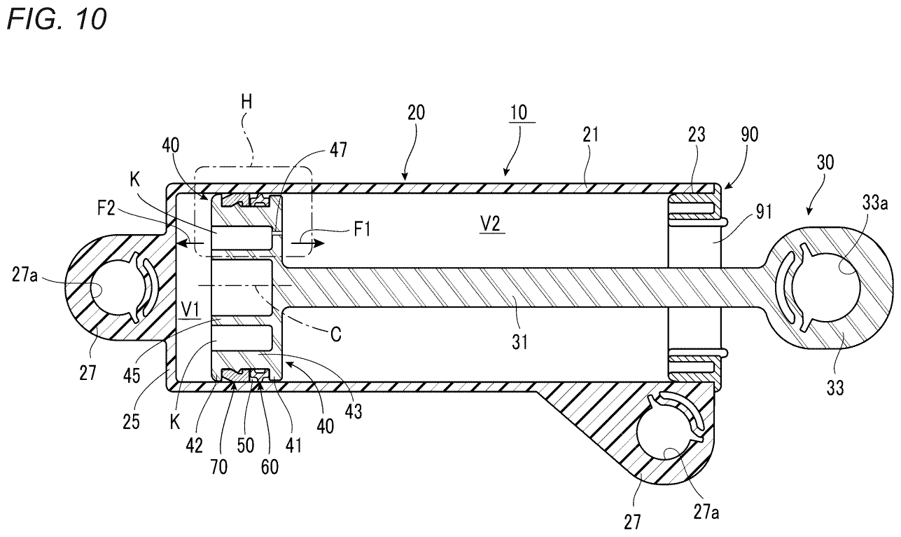

In the following description, “one end portion” or “one end” refers to one end portion or one end of the damper device 10 in a damper braking direction, and “the other end portion” or “the other end” refers the other end portion or the other end on a return direction side opposite to the damper braking direction. Further, the “damper braking direction” in the present embodiment refers to a direction in which the piston 40 separates from an end portion wall 25 (see FIG. 10) of the cylinder 20 and an amount of the rod 30 pulled out from the opening portion 23 of the cylinder 20 increases (see an arrow F1 in FIG. 10). In addition, the “return direction opposite to the damper braking direction” (hereinafter, also simply referred to as “damper return direction”) in the present embodiment refers to a direction in which the piston 40 approaches the end portion wall 25 of the cylinder 20 and an amount of the rod 30 pressed into the cylinder 20 increases (see an arrow F2 in FIG. 10).

Further, in the damper device 10, a seal portion is formed between the cylinder 20 and the piston 40 by the seal ring 60 and the friction member 70. An air chamber is formed in the cylinder 20 via the seal portion. In the case of this embodiment, the air chamber is formed in the cylinder 20 on a side of an insertion direction of the rod 30 with respect to the seal portion.

In the embodiment, as shown in FIG. 1L, when the piston 40 is inserted into the cylinder 20, an outer diameter side protruding portion 67 of the seal ring 60, which will be described later, is brought into pressure contact with the inner peripheral surface of the cylinder 20, and the seal portion is formed between the cylinder 20 and the piston 40 to seal a gap therebetween. That is, the outer diameter side protruding portion 67 of the seal ring 60 and the inner peripheral surface of the cylinder 20 form a “seal portion” of the present invention.

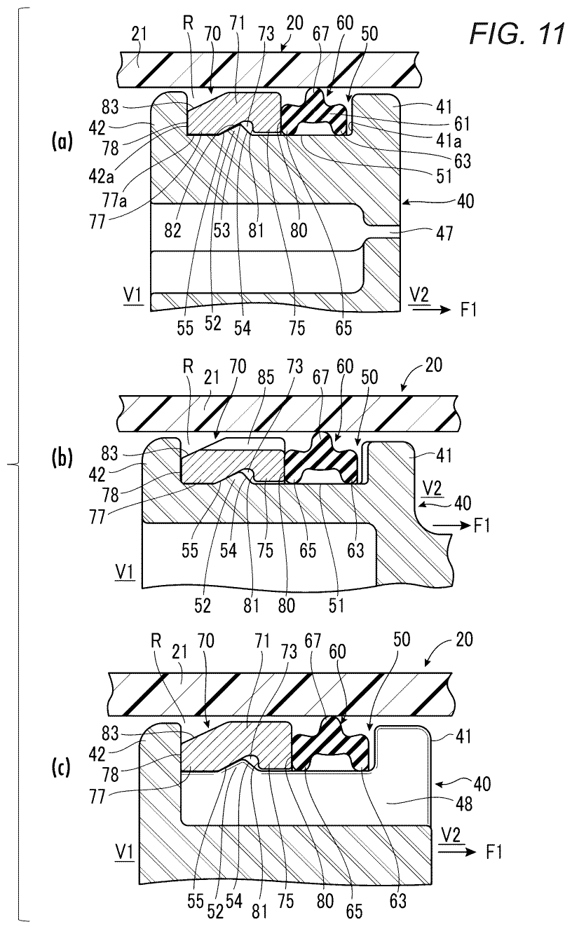

In addition, in a state in which the friction member 70 is mounted on the annular groove 50, the other end surface in the axial direction (a contact surface 78 described later) of the friction member 70 comes into contact with an inner surface of the other end portion in the axial direction of the annular groove 50 (an inner surface 42a of a second side wall portion 42 described later) (see FIGS. 11, 13, and 15), and as shown in FIG. 11, when the piston 40 moves in the damper braking direction F1, the other end portion in the axial direction of the seal ring 60 comes into contact with one end surface in the axial direction of the friction member 70 (a pressing force receiving surface 80 described later). Accordingly, a seal portion is formed between the cylinder 20 and the piston 40 to seal a gap therebetween. That is, the other end portion in the axial direction of the seal ring 60 and the one end surface in the axial direction of the friction member 70, as well as the other end surface in the axial direction of the friction member 70 and the inner surface of the other end portion in the axial direction of the annular groove 50 also form the “seal portion” of the present invention.

In the damper device 10 according to the embodiment, with the plurality of seal portions as a boundary, a first air chamber V1 is formed on the side of the insertion direction of the rod 30 in the cylinder 20, and a second air chamber V2 is formed on a side of the opening portion 23 in the cylinder 20 (see FIG. 10). The first air chamber V1 forms an “air chamber” of the present invention.

The above three seal portions are configured to seal an internal space R within the annular groove 50 when the piston 40 moves in the damper braking direction F1 (see FIG. 11). The internal space R of the annular groove 50 communicates with the first air chamber V1.

As shown in FIG. 1, the wall portion 21 of the cylinder 20 has a cross section perpendicular to the axial direction thereof that is annular with a major axis and a minor axis, and is formed into a thin tubular shape (a tubular shape resembling a thin box) with a major axis side being wider and a minor axis side being narrower. More specifically, the wall portion 21 has a pair of major axis wall portions 21′ and 21a that extend linearly along a major axis direction and are arranged to face each other in parallel, and a pair of minor axis wall portions 21b and 21b that connect both end portions of the major axis wall portions 2ta and 21a to each other and are bent in an arc shape. One end portion in the axial direction of the wall portion 21 is opened, and the opening portion 23 is provided. The major axis wall portions 21a and 21a arranged to face each other around a peripheral edge of the opening portion 23 are formed with engaging holes 23a and 23a, respectively. Further, the end portion wall 25 is disposed at the other end portion in the axial direction of the wall portion 21 (the end portion wall 25 is disposed on a side of the wall portion 21 opposite to the opening portion 23) to close the other end portion of the wall portion 21.

In addition, a rotation support piece 27 having a rotation hole 27a formed therein protrudes from each of an outer surface of the end portion wall 25 and one end portion of an outer periphery of the wall portion 21 in the axial direction. A rotating shaft (not shown) of the one member described above is rotatably inserted into the predetermined rotation hole 27a, and an outer periphery of the cylinder 20 is rotatably coupled to the one member.

As shown in FIG. 1, a rod insertion port 91 through which a shaft portion 31 of the rod 30 can be inserted while being restricted from rotation is formed in a center portion of the detachment prevention cap 90, and the rod 30 can be inserted into the cylinder 20 while being restricted from rotation. Further, a plurality of engaging protrusions 92 are provided on an outer periphery of the detachment prevention cap 90 at predetermined positions. The detachment prevention cap 90 is attached to the opening portion 23 of the cylinder 20 (see FIG. 10) by engaging each of the engaging protrusions 92 with the corresponding engaging hole 23a of the cylinder 20 (see FIG. 2). When the rod 30 is pulled out to the maximum from the opening portion 23 of the cylinder 20, the detachment prevention cap 90 comes into contact with the piston 40 to prevent the rod 30 and the piston 40 from coming off the cylinder 20.

Next, the rod 30 will be described.

The rod 30 is movably inserted into the cylinder 20 through the opening portion 23 of the cylinder 20, and slides in the cylinder 20 in the axial direction of the cylinder 20.

As shown in FIG. 1, the rod 30 in the embodiment has the shaft portion 31 in a shape of a prism that extends long in one direction. A coupling piece 33 having a coupling hole 33a is provided at one end portion in a longitudinal direction of the shaft portion 31. A coupling shaft (not shown) of the other member described above is inserted into the coupling hole 33a, so that the rod 30 is rotatably coupled to the other member.

Next, the piston 40 will be described.

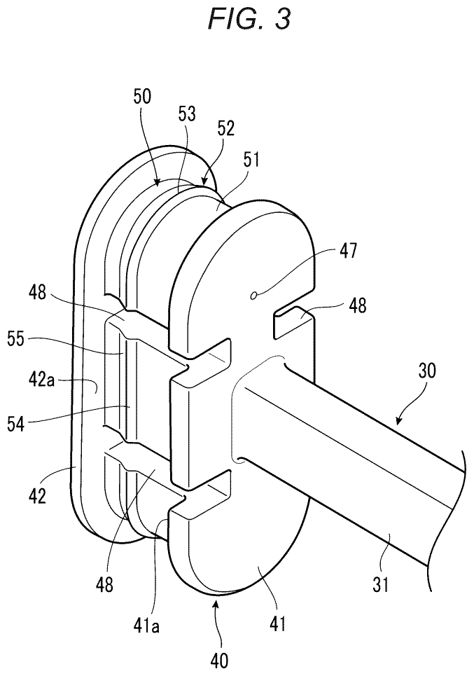

As shown in FIG. 1 and FIG. 3, the piston 40 of the present embodiment is coupled to the other end portion in the longitudinal direction of the rod 30, the annular groove 50 is formed on the outer periphery of the piston 40, and the piston 40 is integrally formed with the rod 30.

Referring also to FIG. 10, the piston 40 includes a first side wall portion 41 and a second side wall portion 42 that are arranged to face each other and be parallel to each other, and a connection wall portion 43 that connects the two side wall portions 41 and 42 to each other. Each of the side wall portions 41 and 42 has a shape conforming to an inner peripheral shape of the wall portion 21 of the cylinder 20, that is, both side surfaces in the major axis direction are parallel to each other and both side surfaces in a minor axis direction have an arc shape. Further, an outer periphery of the connection wall portion 43 has a similar shape smaller than the outer peripheries of the two side wall portions 41 and 42.

A surface of the first side wall portion 41 facing the second side wall portion 42 is defined as an inner surface 41a of the first side wall portion 41, and a surface of the second side wall portion 42 facing the first side wall portion 41 is defined as an inner surface 42a of the second side-wall portion 42.

Further, a base end portion in the axial direction of the rod 30 is coupled to an outer surface of the first side wall portion 41 (a surface opposite to the surface facing the second side wall portion 42) disposed on the one end portion in the longitudinal direction of the piston 40, so that the piston 40 and the rod 30 are integrated.

Further, as shown in FIG. 10, a plurality of spaces K defined by a partition wall 45 are provided inside the side wall portions 41 and 42 and the connection wall portion 43, and each space K is opened on the second side-wall portion 42 side. Referring also to FIG. 3, a round hole-shaped orifice 47 with a small diameter communicating with a predetermined space K is formed at a predetermined position of the first side wall portion 41, here, at a center position in a width direction on one end portion in the axial direction of the first side wall portion 41. The orifice 47 allows the first air chamber V1 and the second air chamber V2 in the cylinder 20 to communicate with each other via the space K. A damper braking force is adjusted by flow resistance of the air passing through the orifice 47.

Further, as shown in FIG. 3, the piston 40 has cutout grooves 48 formed by cutting out the first side wall portion 41 and the connection wall portion 43 to a predetermined depth on both side portions in the major axis direction (the major axis direction of the first side wall portion 41) with the rod 30 interposed therebetween and on both side portions in the width direction (the minor axis direction of the first side wall portion 41) with the rod 30 interposed therebetween (a total of four cutout grooves 48 are formed). When the piston 40 moves in the damper return direction F2, the cutout grooves 48 form an exhaust flow, path (which will be described later) that exhausts the air in the first air chamber V1 to the second air chamber V2.

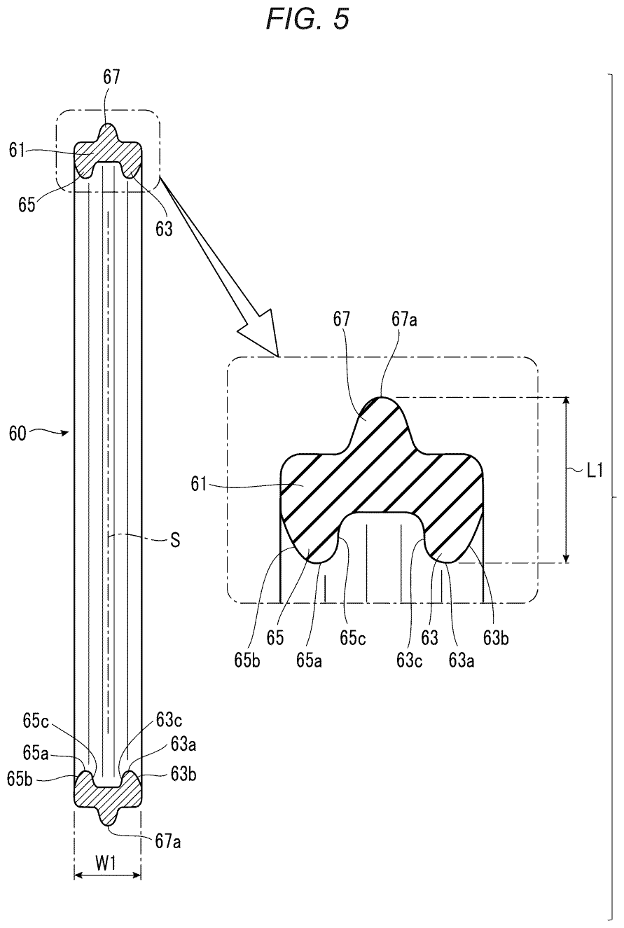

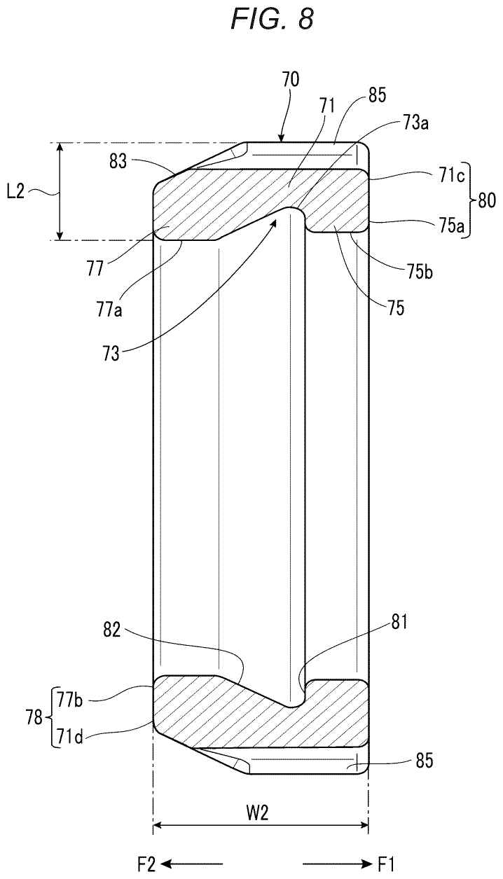

A space surrounded by the pair of side wall portions 41 and 42 and the connection wall portion 43 forms the annular groove 50. Further, an outer peripheral surface of the connection wall portion 43 forms a bottom surface 51 of the annular groove 50. The bottom surface 51 is formed parallel to the axial direction of the piston 40 (the direction along an axis C of the piston 40). A width in the axial direction of the annular groove 50 (a length between the inner surface 41a of the first side wall portion 41 and the inner surface 42a of the second side wall portion 42) is formed to be larger than an axial length W1 of the seal ring 60 (see FIG. 5) and an axial length W2 of the friction member 70 (see FIG. 8), so that the seal ring 60 and the friction member 70 can be received within the annular groove 50.

A annular-shaped ridge 52 extends continuously in a peripheral direction from the bottom surface 51 of the annular groove 50 at a position close to the second side wall portion 42 disposed on the damper return direction F2 side. Further, the annular groove 50 is provided with a friction member movement restricting portion that restricts movement of the friction member 70 in the axial direction when the piston 40 moves in the damper return direction F2.

Both side surfaces in the axial direction of the ridge 52, that is, one side surface in the axial direction on the damper braking direction F1 side and the other side surface in the axial direction on the damper return direction F2 side form inclined surfaces 54 and 55, respectively. Referring also to FIG. 1I, the ridge 52 has a first inclined surface 54 that gradually decreases in height toward the damper braking direction F1 side from a top portion 53 that protrudes highest from the bottom surface 51, and a second inclined surface 55 that gradually decreases in height toward the damper return direction F2 side from the top portion 53 of the ridge 52. The first inclined surface 54 on the damper braking direction F1 side is formed to have a shorter length in the axial direction than the second inclined surface 55 on the damper return direction F2 side.

Further, in the damper device 10, an inclined surface is provided on one of the bottom surface 51 of the annular groove 50 or the friction member 70, and an inclined surface contact portion to come into contact with the inclined surface is provided on the other. In the embodiment, the first inclined surface 54 of the ridge 52 described above forms the “inclined surface” of the ridge 52 in the present invention.

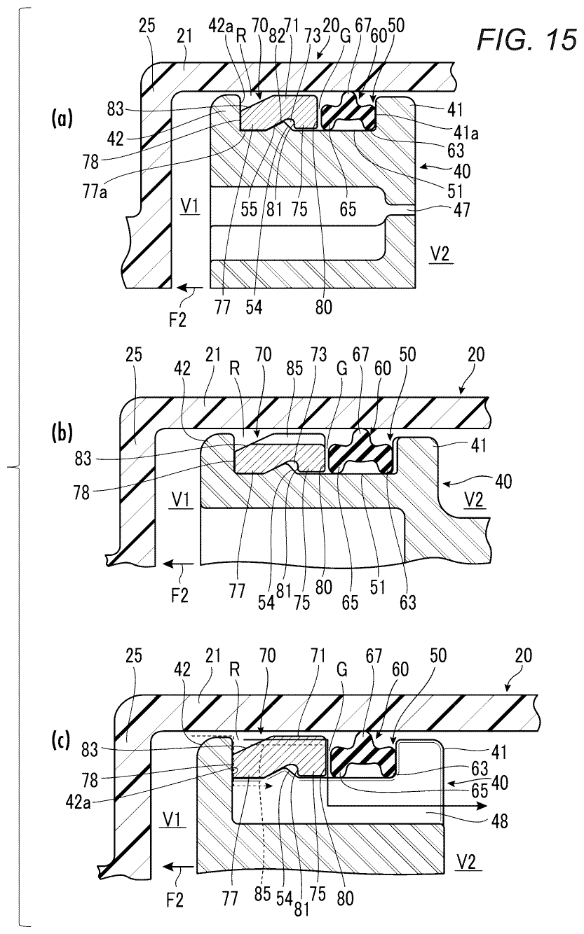

Further, as shown in FIG. 15, when the piston 40 moves in the damper return direction F2, the second inclined surface 55 comes into contact with a friction member side inclined surface 82 of the friction member 70 to be described later to restrict movement in the axial direction (restrict the friction member 70 from moving in the axial direction toward the damper braking direction F1 side). That is, the second inclined surface 55 of the ridge 52 forms the “friction member movement restricting portion” in the present invention.

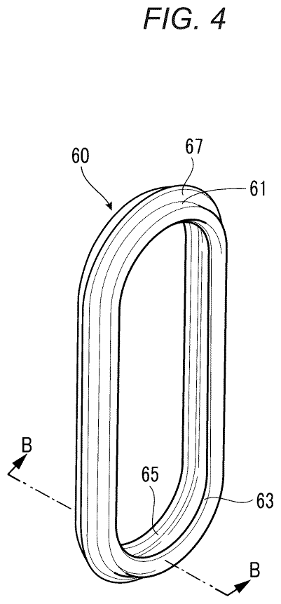

Next, the seal ring 60 will be described with reference to FIGS. 4 and 5.

The seal ring 60 is made of an elastic material such as rubber or elastomer and is flexible and deformable. The seal ring 60 includes a base portion 61 having an annular shape and disposed within the annular groove 50, a first inner diameter side protruding portion 63 and a second inner diameter side protruding portion 65 protruding from both end portions in the axial direction on the inner peripheral surface of the base portion 61, and the outer diameter side protruding portion 67 protruding from an outer peripheral surface of the base portion 61 at a center position in the axial direction and to come into pressure contact with the inner peripheral surface of the cylinder 20.

The first inner diameter side protruding portion 63 is disposed on one end portion side in the axial direction of the base portion 61, that is, on the damper braking direction F1 side, and the second inner diameter side protruding portion 65 is disposed on the other end portion side in the axial direction of the base portion 61, that is, on the damper return direction F2 side.

The base portion 61 has an annular shape conforming to an outer peripheral shape of the annular groove 50. Further, each of the protruding portions 63, 65, and 67 has a shape that is continuous in the peripheral direction so as to form an annular shape from the inner peripheral surface and the outer peripheral surface of the base portion 61 toward an inner side or an outer side in the radial direction of the base portion 61. That is, each protruding portion has an annular shape that is continuous along the peripheral direction of the base portion 61. Each of the inner diameter side protruding portions 63 and 65 has a cross-sectional shape that is substantially a right-angled triangular mountain shape, with an inner side surface 63c, 65c being substantially vertical and an outer side surface 63b, 65b gradually becoming wider toward the inner peripheral surface of the base portion 61 from a top portion 63a, 65a at a tip end in a protruding direction. On the other hand, the outer diameter side protruding portion 67 has a cross-sectional shape that is a substantially equilateral triangular mountain shape (which may also be referred to as a flared shape) that gradually widens toward the outer peripheral surface of the base portion 61 from a top portion 67a at a tip end in the protruding direction. The top portions 63a, 65a, 67a of the protruding portions 63, 65, 67 are rounded.

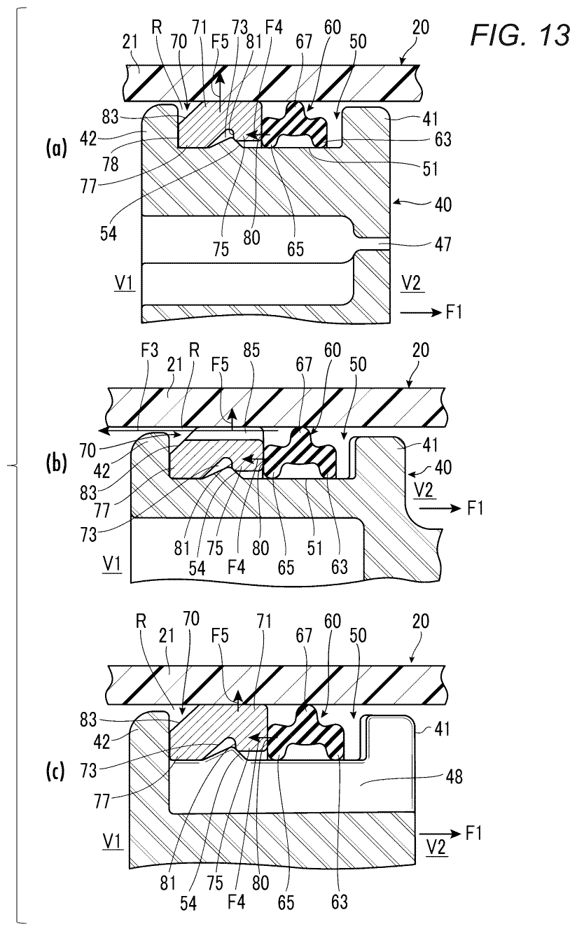

Further, the axial length W1 of the seal ring 60 is formed to be smaller than a length between one end surface in the axial direction of the annular groove 50 (the inner surface 41a of the first side wall portion 41) and the pressing force receiving surface 80 of the friction member 70 to be described later. Accordingly, the seal ring 60 is movable in the axial direction in a space in the annular groove 50 between one end portion in the axial direction of the friction member 70 and one end surface in the axial direction of the annular groove 50, so that the seal ring can come into contact with and be spaced apart from the one end portion in the axial direction of the friction member 70 (see FIGS. 13 and 15).

Specifically, when the piston 40 moves in the damper return direction F2, the seal ring 60 moves in the axial direction in the annular groove 50 so as to be spaced apart from the one end portion in the axial direction of the friction member 70 (see FIG. 15). On the other hand, when the piston 40 moves in the damper braking direction F1, the seal ring 60 moves within the annular groove 50 toward the damper return direction F2 side so as to be drawn in a direction approaching the friction member 70 by a sucking force F3 from the first air chamber V1 (see (b) of FIG. 13), which will be described later, and comes into contact with the one end portion in the axial direction of the friction member 70. As a result, the friction member 70 is pressed and expanded in diameter, and the outer peripheral surface thereof is brought into pressure contact with the inner peripheral surface of the cylinder 20 (which will be described in detail later in the operation description).

As shown in FIG. 5, in a free state of the seal ring 60 before the seal ring 60 is mounted on the annular groove 50, a length L1 in the radial direction from the top portions 63a and 65a of the inner diameter side protruding portions 63 and 65 to the top portion 67a of the outer diameter side protruding portion 67 is larger than a length from the inner peripheral surface of the cylinder 20 to the bottom surface 51 of the annular groove 50. As a result, in a state where the seal ring 60 is mounted on the annular groove 50, when the piston 40 is inserted into the cylinder 20, the top portion 67a of the outer diameter side protruding portion 67 is constantly in pressure contact with the inner peripheral surface of the cylinder 20.

The above “constantly” refers to all states that the piston 40 can be in the cylinder 20, including a state where the piston 40 is stationary, an initial state where the piston 40 starts to move in the damper braking direction F1, a state where the piston 40 has moved a predetermined distance after starting to move in the damper braking direction F1, and a state where the piston 40 moves in the damper return direction F2 (the same applies to the following description).

In the above states, the outer diameter side protruding portion 67 is pressed against the inner peripheral surface of the cylinder 20, causing the seal ring 60 to be bent and to be deformed as shown in FIGS. 11, 13, and 15. Here, portions on both sides of the outer diameter side protruding portion 67 of the base portion 61 are bent and deformed to be slightly curved inward in the radial direction of the seal ring 60, and in conjunction with this, the inner diameter side protruding portions 63, 65 are bent and deformed to spread toward both end portion sides in the axial direction of the seal ring 60.

The entire seal ring 60 as described above has a cross-sectional shape that is line-symmetrical with respect to an axis center line S passing through the center in the axial direction (a line perpendicular to the axial direction of the seal ring 60 and passing through the top portion 67a of the outer diameter side protruding portion 67) (see FIG. 5). Further, all portions forming the seal ring 60, that is, the base portion 61, the inner diameter side protruding portions 63 and 65, and the outer diameter side protruding portion 67 are integrally formed.

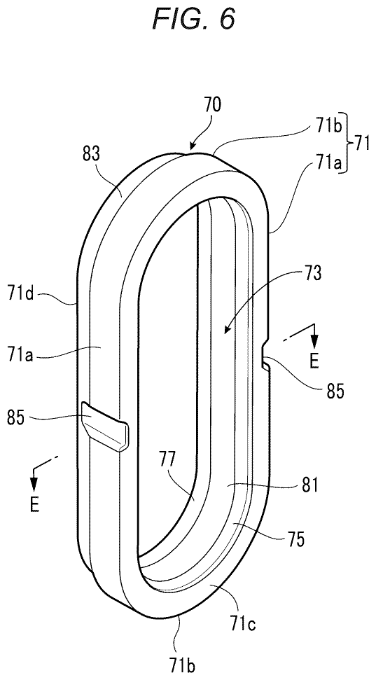

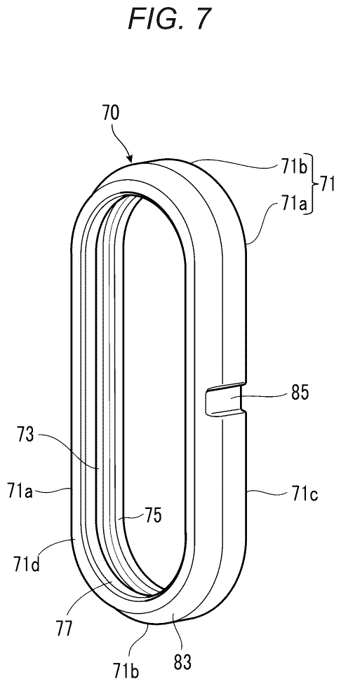

Next, the friction member 70 will be described with reference to FIGS. 6 to 8.

The friction member 70 is made of an elastic material such as rubber or elastomer and is flexible and deformable. The friction member 70 has an annular shape conforming to the outer peripheral shape of the annular groove 50, and has a base portion 71 disposed in the annular groove 50.

Like the wall portion 21 and the like of the cylinder 20, the base portion 71 has an annular shape with a major axis and a minor axis, and includes a pair of major axis portions 71a and 71a that extend linearly along the major axis direction and are arranged to face each other in parallel, and a pair of minor axis portions 71b and 71b that connect both end portions of the major axis portions 71a and 71a to each other and are bent in an are shape. One end surface 71c in the axial direction and the other end surface 71d in the axial direction of the base portion 71 are provided to be perpendicular to the axial direction of the friction member 70.

Further, on an inner periphery of the base portion 71, an annular gap 73 into which the ridge 52 provided in the annular groove 50 is inserted is formed over the entire periphery of the base portion 71. As shown in FIG. 11, the friction member 70 is mounted on the annular groove 50 by disposing the friction member 70 on an outer periphery of the bottom surface 51 of the annular groove 50 such that the ridge 52 is inserted into the gap 73. In this manner, when the friction member 70 is mounted on the annular groove 50 and the ridge 52 is inserted into the gap 73, as shown in FIG. 11, there is a gap in the gap 73, and the first inclined surface 54 of the ridge 52 and an inclined surface contact portion 81 described later are arranged to face each other.

A first annular protruding portion 75, which protrudes inward in the radial direction in an annular shape, is provided on the inner periphery of the base portion 71 from a position on one end portion side in the axial direction, with the gap 73 therebetween, around the entire periphery of the base portion. A second annular protruding portion 77, which protrudes inward in the radial direction in an annular shape, is provided on the inner periphery of the base portion 71 from a position on the other end portion side in the axial direction, with the gap 73 therebetween, around the entire periphery of the base portion. The second annular protruding portion 77 protrudes inward in the radial direction by a greater amount than the first annular protruding portion 75.

A tip end surface 77a in a protruding direction of the second annular protruding portion 77 is a surface parallel to the axial direction of the friction member 70. Further, an outer side surface 77b (a side surface positioned on the other end portion side in the axial direction) of the second annular protruding portion 77 is a surface perpendicular to the axial direction of the friction member 70. The outer side surface 77b of the second annular protruding portion 77 and the other end surface 71d of the base portion 71 form a continuous surface (flush) without a step, and these surfaces form the contact surface 78 that comes into contact with the inner surface of the other end portion in the axial direction of the annular groove 50 (the inner surface 42a of the second side wall portion 42). The contact surface 78 is a surface perpendicular to the axial direction of the friction member 70.

In a state where the ridge 52 is inserted into the gap 73 and the friction member 70 is mounted on the annular groove 50, the tip end surface 77a of the second annular protruding portion 77 comes into contact with the bottom surface 51 of the annular groove 50, and the contact surface 78 is brought into contact with the inner surface of the other end portion in the axial direction of the annular groove 50. In this state, the tip end surface in the protruding direction of the first annular protruding portion 75 is separated from the bottom surface 51 of the annular groove 50.

Further, an outer side surface 75a (a side surface positioned on the one end portion side in the axial direction) of the first annular protruding portion 75 is provided perpendicular to the axial direction of the friction member 70. The outer side surface 75a of the first annular protruding portion 75 and the one end surface 71c of the base portion 71 form a continuous surface (flush) without a step, and these surfaces form the pressing force receiving surface 80 that receives a pressing force F4 (see FIG. 13) from the other end portion in the axial direction of the seal ring 60. The pressing force receiving surface 80 is a surface perpendicular to the axial direction of the friction member 70.

When the piston 40 moves in the damper braking direction F1 and the seal ring 60 is drawn in by the sucking force F3 from the first air chamber V1, the other end portion in the axial direction of the seal ring 60 cones into contact with the pressing force receiving surface 80, so that the pressing force F4 from the seal ring 60 is applied.

An inner side surface of the first annular protruding portion 75 (the side surface located on the other end portion side in the axial direction, which can also be referred to as a surface located on one end portion side in the axial direction of the gap 73) forms the inclined surface contact portion 81 provided perpendicular to the axial direction of the friction member 70. The inclined surface contact portion 81 is disposed to face the first inclined surface 54 of the ridge 52 in a state where the friction member 70 is mounted on the annular groove 50 via the ridge 52. The inclined surface contact portion 81 is separated from the first inclined surface 54 when the piston 40 starts to move in the damper braking direction F1 as shown in FIG. 11. When the piston 40 moves a predetermined distance after starting to move in the damper braking direction F1, the seal ring 60 is drawn in by the sucking force F3 (see (b) of FIG. 13) from the first air chamber V1, and the pressing force F4 from the seal ring 60 is applied, the inclined surface contact portion 81 comes into contact with the first inclined surface 54 provided on the ridge 52 as shown in FIG. 13. As shown in FIG. 15, when the piston 40 moves toward the damper return direction F2, the inclined surface contact portion 81 is separated from the first inclined surface 54 of the ridge 52.

As shown in FIG. 8, the axial length W2 of the friction member 70 is formed smaller than the width in the axial direction of the annular groove 50 (the length between the inner surface 41a of the first side wall portion 41 and the inner surface 42a of the second side wall portion 42) and larger than the axial length W1 of the seal ring 60, so that the friction member 70 is mounted in the annular groove 50 via the ridge 52. In the mounted state, the seal ring 60 is disposed to be movable in the axial direction in a space formed between the one end surface in the axial direction of the friction member 70 (the pressing force receiving surface 80) and the one end surface in the axial direction of the annular groove 50 (the inner surface 41a of the first side wall portion 41).

As described above, the inclined surface contact portion 81 can also be referred to as the surface located on the one end portion side in the axial direction of the gap 73, so that the gap 73 is provided adjacent to the inclined surface contact portion 81.

When the piston 40 moves in the damper braking direction F1 and the pressing force F4 from the seal ring 60 that has moved in the damper return direction F2 due to the sticking force F3 from the first air chamber V1 (see (b) of FIG. 13) is applied to the pressing force receiving surface 80, the friction member 70 moves toward the damper return direction F2 side within the annular groove 50, and the inclined surface contact portion 81 slides on the first inclined surface 54 of the ridge 52. Therefore, the friction member 70 is expanded in diameter, and the outer peripheral surface thereof comes into pressure contact with the inner peripheral surface of the cylinder 20 (see FIG. 13).

The damper device 10 is configured such that when the piston 40 moves in the damper braking direction F1, a contact position on the first inclined surface 54 is changed while the inclined surface contact portion 81 is pressed against the first inclined surface 54, and the friction member 70 is expanded in diameter.

The friction member 70 is smaller than the inner peripheral surface of the cylinder 20 when the pressing force F4 does not act from the seal ring 60.

Specifically, as shown in FIG. 15, in a state in which the other end portion in the axial direction of the seal ring 60 is separated from the pressing force receiving surface 80 and the pressing force F4 from the seal ring 60 does not act, a length L2 (see FIG. 8) in the radial direction from the outer peripheral surface of the friction member 70 to the tip end surface 77a of the second annular protruding portion 77 is smaller than a length from the inner peripheral surface of the cylinder 20 to the bottom surface 51 of the annular groove 50. As a result, as shown in FIG. 15, in a state in which the pressing force F4 from the seal ring 60 does not act on the friction member 70, the outer peripheral surface of the friction member 70 is not in contact with the inner peripheral surface of the cylinder 20. FIG. 11 shows a state in which the other end portion in the axial direction of the seal ring 60 is in contact with the pressing force receiving surface 80, but the pressing force F4 from the seal ring 60 does not act on the friction member 70. Even in the state shown in FIG. 11, the friction member 70 is configured to be smaller than the inner peripheral surface of the cylinder 20 so as not to come into contact with the inner peripheral surface of the cylinder 20.

The friction member side inclined surface 82 is formed on an inner side surface of the second annular protruding portion 77 (a side surface located on one end portion side in the axial direction, which can also be referred to as a surface located on the other end portion side in the axial direction of the gap 73). The friction member side inclined surface 82 is a surface inclined so as to become gradually deeper obliquely inward from one end in the axial direction of the tip end surface 77a in the protruding direction of the second annular protruding portion 77 toward the bottom surface 73a of the gap 73. Further, the friction member side inclined surface 82 is an inclined surface that matches the second inclined surface 55 of the ridge 52. As shown in FIG. 11 and the like, in a state in which the ridge 52 is inserted into the gap 73 and the friction member 70 is mounted on the annular groove 50, the friction member side inclined surface 82 is configured to come into contact (closely contact) with the second inclined surface 55 of the ridge 52 with no gap therebetween.

Further, the friction member 70 is formed with a tapered surface 83 whose diameter decreases toward the damper return direction F2 side on the outer peripheral surface of an end portion on the damper return direction F2 side. In the embodiment, the tapered surface 83, which is inclined so as to gradually reduce in diameter toward the damper return direction F2 side, is formed on the outer peripheral surface of the other end portion in the axial direction located on the damper return direction F2 side of the base portion 71. As shown in FIG. 8, the tapered surface 83 is inclined so as to be substantially parallel to the friction member side inclined surface 82 formed on the second annular protruding portion 77.

A ventilation groove 85 extending along the axial direction is formed on the outer peripheral surface of the friction member 70. In the embodiment, ventilation grooves 85 are respectively extended along the axial direction of the friction member 70 on the outer peripheral surfaces of the pair of major axis portions 71a and 71a of the base portion 71, at the center in the longitudinal direction of each major shaft portion 71a. Each ventilation groove 85 is formed with a constant width and a constant depth from the one end surface 71c in the axial direction of the base portion 71 to the intermediate portion of the inclined surface of the tapered surface 83.

Each ventilation groove 85 is configured to maintain the ventilation even when the friction member 70 is pressed by the seal ring 60 and the outer peripheral surface is in pressure contact with the inner peripheral surface of the cylinder 20 when the piston 40 moves in the damper braking direction F1.

That is, as shown in (b) of FIG. 13, even when the piston 40 moves in the damper braking direction F1 and the outer peripheral surface of the friction member 70, to which the pressing force F4 from the seal ring 60 that has moved in the damper return direction F2 due to the sucking force F3 from the first air chamber V1 is applied, is in pressure contact with the inner peripheral surface of the cylinder 20, the ventilation groove 85 is not crushed and does not come into pressure contact with the inner peripheral surface of the cylinder 20, so that an internal space is secured and the ventilation is maintained.

Next, the operation of the seal ring 60 and the friction member 70 in the annular groove 50 when the piston 40 moves in the damper braking direction F1 and when the piston 40 moves in the damper return direction F2 will be described.

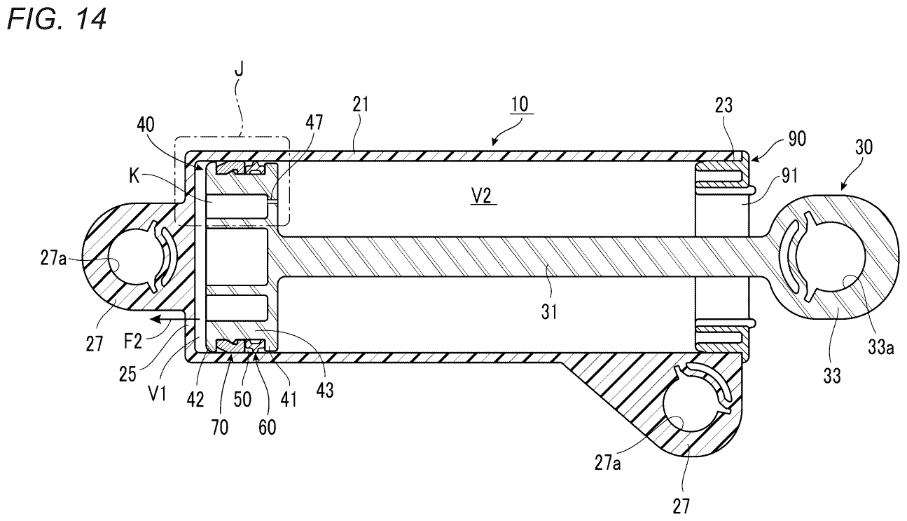

The state where the piston 40 is stationary is basically the same as the state where the piston 40 is moved in the damper return direction F2 (see FIGS. 14 and 15).

That is, the top portion 67a of the outer diameter side protruding portion 67 is in pressure contact with the inner peripheral surface of the cylinder 20, the top portions 63a and 65a of the inner diameter side protruding portions 63 and 65 are in contact with the bottom surface 51 of the annular groove 50, and the other end portion in the axial direction of the seal ring 60 is separated from the pressing force receiving surface 80 of the friction member 70 with a gap G (see FIG. 15) formed therebetween. The gap G communicates with the internal space R of the annular groove 50 and the cutout groove 48 provided in the piston 40 (see (c) of FIG. 15). Therefore, the first air chamber V1 and the second air chamber V2 are in communication with each other via the gap G, the internal space R, and the cutout groove 48. The seal ring 60 is disposed in the cylinder 20 in a deformed state from the seal ring free state shown in FIG. 5.

Further, the contact surface 78 of the friction member 70 is in contact with the inner surface of the other end portion in the axial direction of the annular groove 50 (the inner surface 42a of the second side wall portion 42), and the tip end surface 77a of the second annular protruding portion 77 is in contact with the bottom surface 51 of the annular groove 50. In this state, since the pressing force F4 from the seal ring 60 does not act on the friction member 70, the friction member 70 is not expanded in diameter, and the outer peripheral surface thereof is not in contact with the inner peripheral surface of the cylinder 20 and is separated therefrom.

Then, as shown in FIG. 10, when the piston 40 starts to move in the damper braking direction F1, a frictional force (frictional force in the damper return direction F2) acts on the outer diameter side protruding portion 67 from the inner peripheral surface of the cylinder 20 in the direction opposite to the damper braking direction F1, so that the seal ring 60 is pressed in the damper return direction F2 by the same frictional force. As a result, as shown in FIG. 11, the other end portion in the axial direction of the seal ring 60 comes into contact with the pressing force receiving surface 80 of the friction member 70. In other words, as shown in (c) of FIG. 11, the gap G (see FIG. 15) between the other end portion in the axial direction of the seal ring 60 and the pressing force receiving surface 80 of the friction member 70 disappears, and the air flow between the first air chamber V and the second air chamber V2 via the gap G, the internal space R of the annular groove 50, and the cutout groove 48 is obstructed, so that the first air chamber V1 in the cylinder 20 is depressurized, and the damper braking force is exerted.

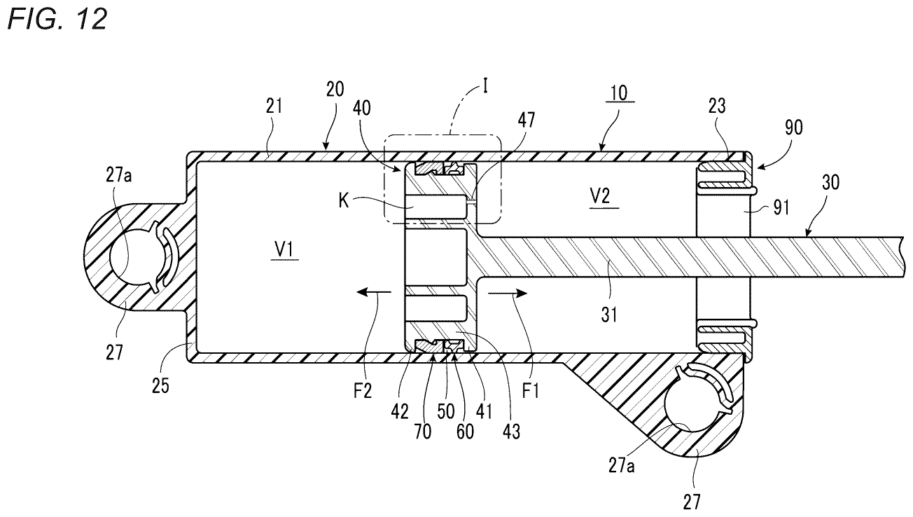

Thereafter, as shown in FIG. 12, when the piston 40 moves by a predetermined distance in the damper braking direction F1, the seal ring 60 is further pressed toward the damper return direction F2 side by the frictional force from the inner peripheral surface of the cylinder 20 in the damper return direction F2. At the same time, as the piston 40 moves in the damper braking direction F1, the first air chamber V1 is further depressurized than the state shown in FIG. 10, that is, as the pressure in the first air chamber V1 changes (in the embodiment, depressurized), the sucking force F3 (see (b) of FIG. 13) from the first air chamber V1 acts on the seal ring 60, and the seal ring 60 is further moved so as to be drawn in the damper return direction F2. The sucking force F3 from the first air chamber V1 is applied to the seal ring 60 by the air in the first air chamber V1 flowing through the internal space R of the annular groove 50 and the pair of ventilation grooves 85, 85 provided in the friction member 70.

As a result, as shown in FIG. 13, the other end portion in the axial direction of the seal ring 60 presses the pressing force receiving surface 80 of the friction member 70, and the pressing force F4 is applied to the inclined surface contact portion 81. Then, the inclined surface contact portion 81 presses against the first inclined surface 54 of the ridge 52 and slides on the first inclined surface 54 (moves in a sliding manner by climbing up onto the first inclined surface 54), so that the contact position on the first inclined surface 54 gradually changes. In this way, the first inclined surface 54 converts a direction of the movement (movement toward the damper return direction F2) of the seal ring 60 along the axial direction of the piston 40 into a direction toward the outer side in the radial direction of the piston 40. As a result, as shown in FIG. 13, the friction member 70 is expanded in diameter, and the outer peripheral surface thereof is brought into pressure contact with the inner peripheral surface of the cylinder 20 as indicated by an arrow F5 (a force in the direction of the arrow F5 at this time, that is, a pressure contact force of the friction member 70 against the inner peripheral surface of the cylinder 20, is also referred to as “pressure contact force F5”). In this way, as the seal ring 60 moves toward the damper return direction F2 due to the sucking force F3 from the first air chamber V1 caused by the pressure change in the first air chamber V1, the friction member 70 is pressed and the outer peripheral surface thereof comes into pressure contact with the inner peripheral surface of the cylinder 20, so that a frictional force of the friction member 70 against the inner peripheral surface of the cylinder 20 is generated.

As described above, in the damper device 10, when the piston 40 moves in the damper braking direction F1, the friction member 70 is pressed against the seal ring 60 by the pressure change in the air chamber and the frictional force of the seal ring 60 against the inner peripheral surface of the cylinder 20, so that the frictional force of the friction member 70 against the inner peripheral surface of the cylinder 20 is generated. At this time, a high damper braking force is exerted, including resistance due to the pressure change in the first air chamber V1, the frictional force of the seal ring 60 against the inner peripheral surface of the cylinder 20, and the frictional force of the friction member 70 against the inner peripheral surface of the cylinder 20. That is, in the damper device 10, a damper braking force that includes the resistance due to the pressure change in the first air chamber V1, the frictional force of the seal ring 60 against the inner peripheral surface of the cylinder 20, and the frictional force of the friction member 70 against the inner peripheral surface of the cylinder 20 can be exerted.

On the other hand, as shown in FIG. 14, when the piston 40 moves in the damper return direction F2, a frictional force acts on the outer diameter side protruding portion 67 of the seal ring 60 from the inner peripheral surface of the cylinder 20 in the direction opposite to the damper return direction F2, so that the seal ring 60 is pressed in the damper braking direction F1 by the same frictional force. As a result, as shown in FIG. 15, when the one end portion in the axial direction of the seal ring 60 comes into contact with an inner surface of one end in the axial direction of the annular groove 50 (the inner surface 41a of the first side wall portion 41), the other end portion in the axial direction of the seal ring 60 is separated from the pressing force receiving surface 80 of the friction member 70. Then, the friction member 70 elastically returns to the original shape, as the pressure contact force F5 no longer acts on the inner peripheral surface of the cylinder 20, the gap G is generated again between the other end portion in the axial direction of the seal ring 60 and the pressing force receiving surface 80 of the friction member 70. As a result, as indicated by arrows in (c) of FIG. 15, the air in the first air chamber V1 in the cylinder 20 passes through the internal space R of the annular groove 50, the pair of ventilation grooves 85 and 85 of the friction member 70, the gap G1, and the plurality of cutout grooves 48 in this order, and then flows out into the second air chamber V2. As a result, the damper braking force is released.

### Modifications

The shape and structure of a cylinder, a rod, a piston, a seal ring, and the like that form the damper device according to the present invention are not limited to those described above.

In the embodiment, the wall portion 21 of the cylinder 20 has a substantially thin box shape. Alternatively, the wall portion of the cylinder may be, for example, substantially rectangular cylinder-shape or substantially cylindrical. In this case, it is preferable that the rod, the piston, the seal ring, the seal cap, the detachment prevention cap, and the like are also shaped to correspond to the wall portion of the cylinder.

In the embodiment, the cylinder 20 is closed by disposing the end portion wall 25 on the other end portion in the axial direction. Alternatively, a through hole may be formed in the end portion wall disposed on the other end portion of the cylinder, for example, and the through hole may be opened and closed by a seal cap.

Further, in the embodiment, the rod 30 has the shaft portion 31 in the shape of a prism. Alternatively, the rod may be, for example, a structure including a shaft portion and a pair of side walls disposed on both sides of the shaft portion via a plurality of portions, or a structure including a shaft portion having a long plate shape or a column shape, as long as the rod 30 and the piston can be connected.

Further, in the embodiment, the bottom surface 51 of the annular groove 50 in the piston 40 is parallel to the axial direction of the piston 40. Alternatively, the annular groove may have, for example, an inclined or stepped bottom surface.

Further, in the embodiment, the inner diameter side protruding portions 63, 65 are provided to protrude from both end portions in the axial direction of the inner peripheral surface of the seal ring 60. Alternatively, three or more inner diameter side protruding portions may be disposed inward in the axial direction with respect to both end portions in the axial direction of the inner peripheral surface. Further, the outer diameter side protruding portion 67 is disposed at the center in the axial direction of the seal ring 60, but the position may be changed. However, it is preferable that the top portion of the outer diameter side protruding portion is provided at a position shifted from the top portion of the inner diameter side protruding portions without overlapping in the axial direction.

Further, in the embodiment, the seal portion is formed between the cylinder 20 and the piston 40 by the seal ring 60 and the friction member 70. Alternatively, the seal portion may be formed between the cylinder and the piston by a seal ring.

For example, the seal ring is an O-ring having a circular cross section, and is movably mounted in the annular groove on the outer periphery of the piston. An outer peripheral surface of the seal ring is brought into pressure contact with an inner peripheral surface of the cylinder, and an inner peripheral surface of the seal ring is brought into pressure contact with the bottom surface of the annular groove. Accordingly, the seal ring, which is an O-ring, forms the “seal portion” that seals the gap between the cylinder and the piston. In this case, the friction member may be in contact with the other end surface in the axial direction of the annular groove, or may not be in contact therewith. The bottom surface of the annular groove may not have the cutout groove 48 or the like as in the above embodiment. Instead, an exhaust hole that communicates with the air chamber may be formed at a predetermined location on the cylinder, and a seal cap that enables the exhaust hole to be opened and closed is mounted on a peripheral edge of the exhaust hole. When the piston moves in the damper return direction, the seal cap opens the exhaust hole, so that the air in the air chamber is exhausted and the damper braking force is released.

Further, in the embodiment, the friction member 70 has a structure in which the first annular protruding portion 75 and the second annular protruding portion 77 are provided on the inner periphery thereof via the gap 73. Alternatively, one or three or more annular protruding portions may be provided.

Further, the one end surface 71c and the other end surface 71d in the axial direction of the base portion 71 are flush with the outer side surface 75a of the first annular protruding portion 75 and the outer side surface 77b of the second annular protruding portion 77 without any step. Alternatively, a step may be formed. The contact surface 78 and the pressing force receiving surface 80 are surfaces perpendicular to the axial direction of the friction member 70. Alternatively, the contact surface 78 and the pressing force receiving surface 80 may be inclined at a predetermined angle other than 90° with respect to the axial direction of the friction member.

Further, in the embodiment, the seal ring 60 sucked by the sucking force F3 from the first air chamber V1 applies the pressing force F4 to the friction member 70, so that the inclined surface contact portion 81 of the friction member 70 slides on the first inclined surface 54 of the ridge 52 provided in the annular groove 50 to expand the friction member 70 in diameter. However, the structure for expanding the diameter of the friction member by the seal ring is not limited to this manner.

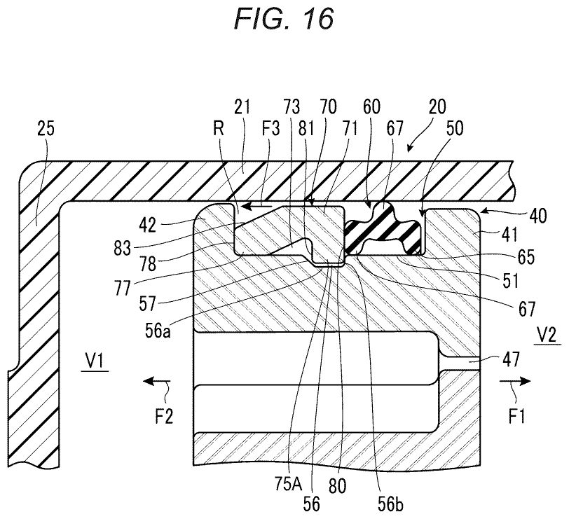

FIG. 16 shows a modification.

That is, an annular recessed groove 56 is formed in the bottom surface 51 of the annular groove 50. An inclined surface 57 is formed on an inner side surface of the recessed groove 56 on the damper return direction F2 side. The inclined surface 57 is an inclined surface that protrudes from the bottom surface 56a of the recessed groove 56 so as to gradually increase in height toward the damper return direction F2. A first annular protruding portion 75A of the friction member 70 protrudes inward in the radial direction by a greater amount than the second annular protruding portion 77. A tip end portion in the protruding direction of the first annular protruding portion 75A enters the recessed groove 56, and the inclined surface contact portion 81 provided on an inner side surface of the first annular protruding portion 75A is disposed to face the inclined surface 57 of the recessed groove 56.

An opposing surface 56b, which is perpendicular to the axial direction of the piston 40 and disposed to face the inclined surface 57, is provided on an inner side surface on the damper braking direction F1 side of the recessed groove 56. The opposing surface 56b forms the “friction member movement restricting portion” in the present invention that comes into contact with the pressing force receiving surface 80 of the friction member 70 to restrict movement of the friction member 70 in the axial direction when the piston 40 moves in the damper return direction F2.

Then, when the seal ring 60 is sucked by the sucking force F3 from the first air chamber V1 and the seal ring 60 applies the pressing force F4 to the friction member 70, the inclined surface contact portion 81 slides on the inclined surface 57, so that the friction member 70 is expanded in diameter.

Further, in the embodiment, when the piston 40 moves in a direction away from the end portion wall 25 of the cylinder 20 (when the piston 40 moves in the damper braking direction F1), a braking force due to the pressure reduction in the first air chamber V1 acts, and when the piston 40 moves in a direction toward the end portion wall 25 of the cylinder 20 (when the piston 40 moves in the damper return direction F2), the braking force is released. Alternatively, contrary to the above configuration, the damper braking force may be applied when the piston 40 moves in the direction toward the end portion wall 25 of the cylinder 20, and the damper braking force may be released when the piston 40 moves in the direction away from the end portion wall 25 of the cylinder 20 (this will be described later in another embodiment).

Further, in the embodiment, when the piston 40 moves in the damper return direction F2, the gap G is generated between the other end portion in the axial direction of the seal ring 60 and the pressing force receiving surface 80 of the friction member 70, and the air in the first air chamber V1 in the cylinder 20 flows out to the second air chamber V2 as indicated by the arrows in (c) of FIG. 15. However, when the piston 40 moves in the damper return direction F2, the other end surface (the contact surface 78) in the axial direction of the friction member 70 may be separated from the inner surface of the other end portion in the axial direction of the annular groove 50 (the inner surface 42a of the second side wall portion 42), the seal between the contact surface 78 of the friction member 70 and the inner surface 42a of the annular groove 50 may be released, and the gap between the contact surface 78 of the friction member 70 and the inner surface 42a of the annular groove 50 may be used as an air flow passage. In this case, as indicated by a dashed arrow in (c) of FIG. 15, the air in the first air chamber V1 in the cylinder 20 passes through the internal space R of the annular groove 50, the gap, and the cutout grooves 48 in this order, and flows out to the second air chamber V2.

Further, in the embodiment, the seal ring 60 is moved toward the damper return direction F2 by the sucking force F3 from the first air chamber V1. Alternatively, for example, the seal ring may be moved in the damper return direction by pressure from the first air chamber (this is described in another embodiment), as long as the seal ring can be moved in the damper return direction in response to the pressure change in the air chamber.

In the embodiment, the one member is a fixed body such as an accommodation portion of an instrument panel, and the other member is an openable and closable body such as a glove box or a lid. Alternatively, the present disclosure is not limited thereto as long as the pair of members can approach and separate from each other.

Further, in the embodiment, the air chamber (the first air chamber V1) is formed in the cylinder 20 on the side of the insertion direction of the rod 30 with respect to the seal portion. Alternatively, an air chamber may be provided in the cylinder on a side opposite to the insertion direction of the rod. For example, an exhaust hole is formed in an end portion wall of the cylinder, and a seal cap capable of opening and closing the exhaust hole is mounted to a peripheral edge of the exhaust hole. Further, the cap mounted on the opening portion at the one end portion of the cylinder has a structure capable of sealing a peripheral edge of the opening portion, and capable of sealing a gap between the rod insertion port and the rod inserted through the rod insertion port, and a sealed air chamber is provided in the cylinder on the side opposite to the insertion direction of the rod. When the piston moves in the direction away from the end portion wall of the cylinder (moves in a direction opposite to the insertion direction of the rod), the air chamber is pressurized to exert a damper braking force. When the piston moves toward the end portion wall of the cylinder (moves in the insertion direction of the rod), the seal cap opens the exhaust hole, the air in the air chamber is exhausted, and the damper braking force is released.

### Operations and Effects

Next, operations and effects of the damper device 10 configured as described above will be described.

In the damper device 10, the piston 40 is in a stationary state in the cylinder 20 when the one member (fixed body or the like) and the other member (openable and closable body or the like) are close to each other. In this state, the top portion 67a of the outer diameter side protruding portion 67 comes into contact with the inner peripheral surface of the cylinder 20, and the seal ring 60 is disposed in the annular groove 50 when the top portions 63a and 65a of the inner diameter side protruding portions 63 and 65 are in contact with the bottom surface 51 of the annular groove 50.

From the above state, when the one member moves in a direction away from the other member (when the openable and closable body is opened from the fixed body), that is, when the piston 40 starts to move in the damper braking direction F1 as shown in FIG. 10, as the piston 40 moves in the damper braking direction F1 within the cylinder 20, the rod 30 is pulled out from the opening portion 23 of the cylinder 20. Then, as described above in paragraph 0074, the first air chamber V in the cylinder 20 is depressurized, so that a damper braking force is applied to the piston 40.

Thereafter, as shown in FIG. 12, when the piston 40 moves by a predetermined distance in the damper braking direction F1, the seal ring 60 moves toward the damper return direction F2 as the pressure in the air chamber changes (in the embodiment, depressurized). Then, as described above in paragraphs 0075 to 0077, the sucking force F3 from the first air chamber V1 acts on the seal ring 60, and the seal ring 60 moves in the damper return direction F2. As a result, as shown in FIG. 13, the seal ring 60 applies the pressing force F4 to the friction member 70, and the friction member 70 is expanded in diameter, so that the outer peripheral surface of the friction member 70 is brought into pressure contact with the inner peripheral surface of the cylinder 20 with a predetermined pressure contact force F5.

In this way, in the damper device 10, when the piston 40 moves in the damper braking direction F1, the friction member 70 is pressed against the seal ring 60 by the pressure change in the first air chamber V1 and the frictional force of the seal ring 60 against the inner peripheral surface of the cylinder 20, and the friction member can be sufficiently deformed, so that the outer peripheral surface of the friction member 70 can be brought into pressure contact with the inner peripheral surface of the cylinder 20. As a result, in addition to the frictional force of the seal ring 60 against the inner peripheral surface of the cylinder 20, a frictional force of the friction member 70 can be generated against the inner peripheral surface of the cylinder 20. In this way, it is possible to obtain a high damper braking force including the resistance due to the pressure change in the first air chamber V1, the frictional force of the seal ring 60 against the inner peripheral surface of the cylinder 20, and the frictional force of the friction member 70 against the inner peripheral surface of the cylinder 20, so that the one member can be moved slowly with respect to the other member (the openable and closable body can be opened slowly from the fixed body).

The friction member 70 forming the damper device 10 is configured to be smaller than the inner peripheral surface of the cylinder 20 when the pressing force F4 does not act from the seal ring 60, and therefore the following effects (1) to (3) can be obtained.

(1) At the time of damper braking, the friction member 70 can be easily expanded in diameter and brought into pressure contact with the inner peripheral surface of the cylinder 20 (if the friction member 70 is larger than the inner peripheral surface of the cylinder 20, there is little or no room for the friction member 70 to expand in diameter, and it is difficult to expand the diameter when pressed by the seal ring 60).

(2) When the damper braking force is released (when the piston 40 is moved in the damper return direction F2), a wide air flow passage is ensured and the air in the first air chamber V1 can be quickly exhausted to the second air chamber V2, so that return resistance of the piston 40 can be reduced and a force for operating the piston 40 can be reduced.

(3) When the damper braking force is released, no frictional force is generated between the friction member 70 and the inner peripheral surface of the cylinder 20, so that the return resistance of the piston 40 can be reduced and the force for operating the piston 40 can be reduced.

Further, in the embodiment, as shown in FIGS. 11 and 13, an inclined surface is provided on one of the bottom surface 51 of the annular groove 50 or the friction member 70 (here, the first inclined surface 54 is provided on the ridge 52 of the annular groove 50), and an inclined surface contact portion to come into contact with inclined surface is provided on the other of the bottom surface 51 of the annular groove 50 or the friction member 70 (here, the inclined surface contact portion 81 is provided on the friction member 70). When the piston 40 moves in the damper braking direction F1, the inclined surface contact portion 81 is pressed against the first inclined surface 54 while the contact position on the first inclined surface 54 changes, and the friction member 70 is expanded in diameter.

According to the above aspect, at the time of damper braking, when the friction member 70 receives the pressing force F4 from the seal ring 60, the friction member 70 can be more easily expanded in diameter outward in the radial direction. As a result, the frictional force of the friction member 70 against the inner peripheral surface of the cylinder 20 can be further increased, and a higher damper braking force can be obtained.

Further, in the embodiment, as shown in FIGS. 11 and 13, the ridge 52 extending in the peripheral direction is provided on the bottom surface 51 of the annular groove 50. The surface on the damper braking direction F1 side of the ridge 52 forms an inclined surface (first inclined surface 54), and the gap 73 is provided in a portion of the friction member 70 adjacent to the inclined surface contact portion 81.

According to the above aspect, due to the gap 73 formed in the portion of the friction member 70 adjacent to the inclined surface contact portion 8L so that when the friction member 70 receives the pressing force from the seal ring 60 at the time of damper braking, the friction member 70 can be made to expand in diameter even more easily, and a higher damper braking force can be obtained. Further, the friction member 70 can be easily mounted to the annular groove 50 by using the ridge 52 provided on the bottom surface 51 of the annular groove 50 and the gap 73 provided in the friction member 70. That is, when fitting the friction member 70 into the annular groove 50 while the friction member 70 is expanded in diameter, by disposing the friction member 70 in the annular groove 50 such that the ridge 52 is inserted into the gap 73, the gap 73 is caught by the ridge 52, making it difficult for the friction member 70 to shift position, and therefore the friction member 70 can be easily mounted on the annular groove 50.

In addition, in the embodiment, as shown in FIGS. 6 to 8, the ventilation grooves 85 extending along the axial direction are formed on the outer peripheral surface of the friction member 70, and the ventilation grooves 85 are configured to maintain the ventilation even when the friction member 70 is pressed by the seal ring 60 and the outer peripheral surface is in pressure contact with the inner peripheral surface of the cylinder 20 when the piston 40 moves in the damper braking direction F1 (see (b) of FIG. 13).

According to the above aspect, even when the friction member 70 is expanded in diameter at the time of damper braking and the outer peripheral surface of the friction member 70 is brought into pressure contact with the inner peripheral surface of the cylinder 20, the ventilation of the ventilation grooves 85 is maintained, so that an air passage communicating with the first air chamber V1 (here, also communicating with the internal space R of the annular groove 50) can be secured, and the sucking force F3 from the first air chamber V1 can be reliably applied to the seal ring 60.

In addition, when the other member is moved in a direction approaching the one member (when the openable and closable body is closed with respect to the fixed body), as shown in FIG. 14, the piston 40 moves in the damper return direction F2 in the cylinder 20, and the rod 30 is pushed into the cylinder 20.

Then, a frictional force acts on the outer diameter side protruding portion 67 from the inner peripheral surface of the cylinder 20 in the direction opposite to the damper return direction F2, so that the seal ring 60 is pressed in the damper braking direction F1 by the same frictional force. As described above in paragraph 0078, as indicated by arrows in (c) of FIG. 15, the air in the first air chamber V1 in the cylinder 20 passes through the internal space R of the annular groove 50, the pair of ventilation grooves 85 and 85 of the friction member 70, the gap G, and the plurality of cutout grooves 48 in this order, and then flows out into the second air chamber V2, so that the damper braking force is released.

At this time, in the embodiment, the friction member 70 is formed with the tapered surface 83 whose diameter decreases toward the damper return direction F2 side on the outer peripheral surface of the end portion on the damper return direction F2 side.

According to the above aspect, when the piston 40 moves in the damper return direction F2, the friction member 70 can be prevented from being caught by the inner peripheral surface of the cylinder 20, and the force for operating the piston 40 can be reduced.

Further, in the embodiment, the annular groove 50 is provided with the friction member movement restricting portion (here, the second inclined surface 55 of the ridge 52) that restricts movement of the friction member 70 in the axial direction when the piston 40 moves in the damper return direction F2.

According to the above aspect, when the piston 40 moves in the damper return direction F2, the friction member side inclined surface 82 of the friction member 70 comes into contact with the second inclined surface 55 of the ridge 52 that forms the friction member movement restricting portion, and the friction member 70 is restricted from moving in the axial direction (movement toward the damper braking direction F1 side), so that when the piston 40 moves in the damper return direction F2, the seal ring 60 and the friction member 70 can be easily separated from each other. As a result, the friction member 70 can be rapidly reduced in diameter, so that the force for operating the piston 40 can be reduced, and an air passage (gap G: see FIG. 15) can be formed between the seal ring 60 and the friction member 70.

### Damper According to Other Embodiments

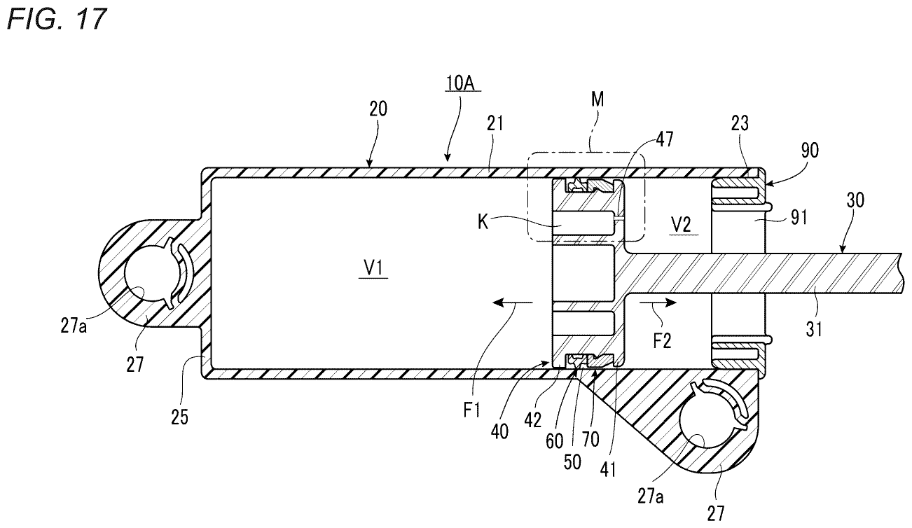

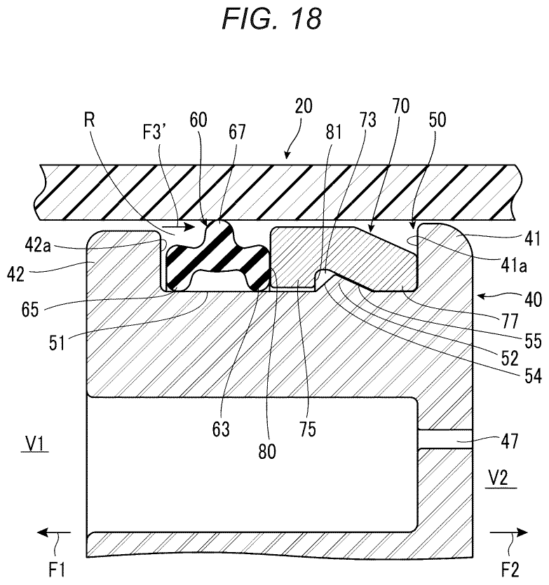

A damper device according to another embodiment of the present invention is shown in FIGS. 17 and 18. The same reference signs are given to substantially the same parts as those in the above-described embodiments, and description thereof will be omitted.

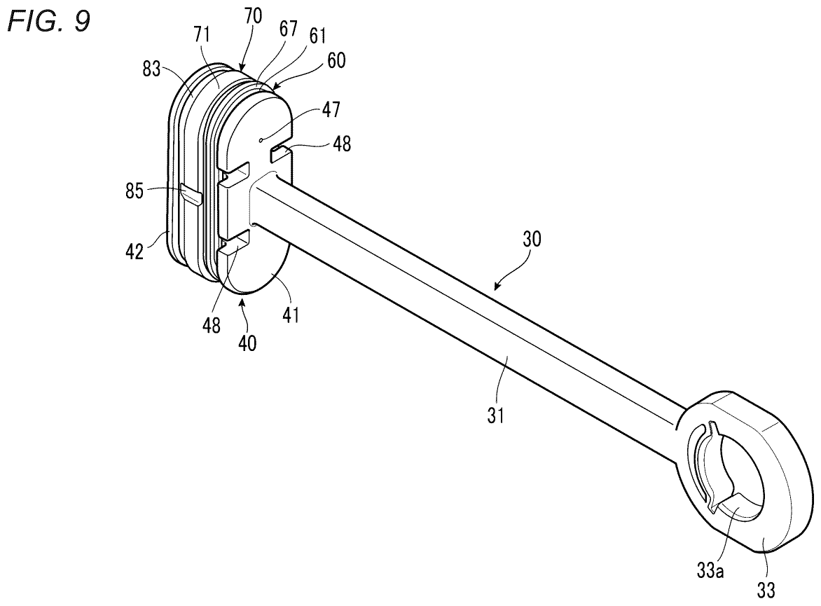

A damper device 10A according to the embodiment is structured in a manner opposite to that of the damper device 10 shown in FIGS. 1 to 16, in which a braking force is applied when the piston 40 moves in a direction approaching the end portion wall 25 of the cylinder 20, and the braking force is released when the piston 40 moves in a direction away from the end portion wall 25 of the cylinder 20.

That is, in the embodiment, the arrangement of the seal ring 60 and the friction member 70 with respect to the annular groove 50 is opposite to the arrangement of the seal ring 60 and the friction member 70 in the damper device 10 shown in FIGS. 1 to 16.

Specifically, as shown in FIG. 18, the ridge 52 is provided on the bottom surface 51 of the annular groove 50 at a position close to the first side wall portion 41. A side surface of the ridge 52 that faces the second side wall portion 42 forms the first inclined surface 54, and an inclined surface that faces the first side wall portion 41 forms the second inclined surface 55. The friction member 70 is mounted on the annular groove 50 via the ridge 52 such that the pressing force receiving surface 80 faces the second side wall portion 42. Further, the seal ring 60 is disposed in the annular groove 50 so as to be movable in the axial direction, with one end portion in the axial direction facing the friction member 70 and the other end portion in the axial direction facing the second side wall portion 42, and the one end portion in the axial direction of the seal ring 60 is configured to press against the pressing force receiving surface 80 of the friction member 70.

When the piston 40 starts to move in the damper braking direction F1 and moves by a predetermined distance, the seal ring 60 is pressed toward the damper return direction F2 by the frictional force from the inner peripheral surface of the cylinder 20 in the damper return direction F2, and a pressing force F3′ from the first air chamber V1 acts on the seal ring 60 as the pressure in the first air chamber V1 changes (pressurizes), causing the seal ring 60 to move in the damper return direction F2. As a result, the friction member 70 is pressed and expanded in diameter, and the outer peripheral surface of the friction member 70 comes into pressure contact with the inner peripheral surface of the cylinder 20 with a predetermined pressure contact force, so that a frictional force can be generated between the friction member 70 and the inner peripheral surface of the cylinder 20, and a high damper braking force can be obtained.

The present invention is not limited to the embodiment described above, various modifications can be made within the scope of the gist of the present invention, and such embodiments are also included in the scope of the present invention.

### REFERENCE SIGNS LIST

10, 10A damper device
20: cylinder
30 rod
40 piston
50 annular groove
51 bottom surface
52 ridge
54 first inclined surface (inclined surface)
60 seal ring
70 friction member
7 gap
75 first annular protruding portion
77 second annular protruding portion
78 contact surface
80 pressing force receiving surface
81 inclined surface contact portion
83 tapered surface
85 ventilation groove
90 prevention cap

1. A damper device configured to be attached between a pair of members that are configured to move toward or away from each other, and configured to apply a braking force when the pair of members move toward or away from each other, the damper device comprising:
a cylinder having an opening portion at one end portion;
a rod movably inserted into the cylinder through the opening portion;
a piston connected to the rod and having an annular groove formed on an outer periphery thereof;
a seal ring disposed in the annular groove on a side of a damper braking direction in a manner of being movable in an axial direction and configured to come into pressure contact with an inner peripheral surface of the cylinder; and
a friction member disposed in the annular groove on a side of a return direction opposite to the damper braking direction with respect to the seal ring,
wherein a seal portion is formed between the cylinder and the piston by the seal ring and the friction member, or by the seal ring,
wherein an air chamber is formed in the cylinder via the seal portion,
wherein when the piston moves in the damper braking direction, the seal ring is configured to press the friction member to expand the friction member in diameter, and an outer peripheral surface of the friction member is configured to be brought into pressure contact with an inner peripheral surface of the cylinder,
wherein the friction member is formed to be smaller than a size of the inner peripheral surface of the cylinder when no pressing force is applied from the seal ring,
wherein an inclined surface is provided on one of the friction member and a bottom surface of the annular groove, and an inclined surface contact portion configured to come into contact with the inclined surface is provided on the other of the friction member and the bottom surface of the annular groove, and
wherein when the piston moves in the damper braking direction, the inclined surface contact portion is configured to be pressed against the inclined surface while a contact position on the inclined surface changes, and the friction member is configured to be expanded in diameter.

2. (canceled)

3. The damper device according to claim 1,
wherein the friction member is formed with a tapered surface whose diameter decreases toward the return direction on an outer peripheral surface of an end portion located on the side of the return direction.

4. The damper device according to claim 1,
wherein the annular groove is provided with a friction member movement restricting portion configured to restrict movement of the friction member in the axial direction when the piston moves in the return direction.

5. The damper device according to claim 1,
wherein a ridge extending in a peripheral direction is provided on the bottom surface of the annular groove,
wherein a surface on the side of the damper braking direction of the ridge forms the inclined surface, and
wherein a gap is provided in a portion of the friction member adjacent to the inclined surface contact portion.

6. The damper device according to claim 1,
wherein a ventilation groove extending along the axial direction is formed on the outer peripheral surface of the friction member, and
wherein the ventilation groove is configured to maintain ventilation thereof even when the friction member is pressed by the seal ring and the outer peripheral surface thereof is in pressure contact with the inner peripheral surface of the cylinder when the piston moves in the damper braking direction.

7. A damper device configured to be attached between a pair of members that are configured to move toward or away from each other, and configured to apply a braking force when the pair of members move toward or away from each other, the damper device comprising:
a cylinder having an opening portion at one end portion;
a rod movably inserted into the cylinder through the opening portion;
a piston connected to the rod and having an annular groove formed on an outer periphery thereof;
a seal ring disposed in the annular groove on a side of a damper braking direction in a manner of being movable in an axial direction and configured to come into pressure contact with an inner peripheral surface of the cylinder; and
a friction member disposed in the annular groove on a side of a return direction opposite to the damper braking direction with respect to the seal ring,
wherein a seal portion is formed between the cylinder and the piston by the seal ring and the friction member, or by the seal ring,
wherein an air chamber is formed in the cylinder via the seal portion,
wherein when the piston moves in the damper braking direction, the seal ring is configured to press the friction member to expand the friction member in diameter, and an outer peripheral surface of the friction member is configured to be brought into pressure contact with an inner peripheral surface of the cylinder,
wherein the friction member is formed to be smaller than a size of the inner peripheral surface of the cylinder when no pressing force is applied from the seal ring, and
wherein the seal ring includes a base portion having an annular shape and disposed within the annular groove, at least two inner diameter side protruding portions protruding from an inner diameter side surface of the base portion, and an outer diameter side protruding portion protruding from an outer diameter side surface of the base portion and configured to come into contact with the inner peripheral surface of the cylinder.

8. The damper device according to claim 7,
wherein, of the inner diameter side protruding portions, an outer side surface of one of the inner diameter side protruding portions located on a position closest to the side of the return direction opposite to the damper braking direction is inclined toward another of the inner diameter side protruding portions adjacent to the one of the inner diameter side protruding portions in the axial direction as being away from the inner diameter side surface of the base portion, over entire range from the inner diameter side surface of the base portion to a top portion of the one of the inner diameter side protruding portions.
